(19) United States
(12) Patent Application Publication
(10) Pub. No.: US 2008/0116255 A1
(43) Pub. Date: May 22, 2008

(54) Seamless screen labeling for branding, access control and content management

(75) Inventors: David M. Hilbert, Palo Alto, CA (US); Laurent Denoue, Palo Alto, CA (US); John E. Adcock, Menlo Park, CA (US); Daniel-Alexander Billsus, San Francisco, CA (US)

Correspondence Address: SUGHRUE MION, PLLC, 2100 Pennsylvania Avenue, N.W., Washington, DC, 20037, US

(73) Assignee: FUJI XEROX CO., LTD., TOKYO (JP)

(21) Appl. No.: 11/601,302

(22) Filed: Nov. 17, 2006

(51) Int. Cl. G06F 17/00

(52) U.S. Cl. 235/375

(57) ABSTRACT

Methods and apparatus for assuring that branding or other labels properly appear at all times when images are shared, such as by projecting a presentation. In addition, the automatic labeling is utilized for access control and corporate content management of recorded images. The method operates by causing a computer to monitor a sharing event, and when a sharing event has been detected, causing the computer to overlay at least one of a pre-stored or dynamically generated labels over the shared image. The label is applied only if after analyzing the image it is determined that it is not properly labeled. The label or part of it may include a machine-readable code that may include or point to metadata relating to the image.

### BACKGROUND

1. Field of the Invention

The subject invention relates to automatic branding and labeling of projected or shared images, and to providing access control to recordings of such images.

2. Related Art

Organizations typically want their intellectual property to be branded and labeled. For example, when corporate presentations are given to an external audience, the slides projected are usually branded with a corporate logo and/or textual copyright or confidentiality message. Therefore, those preparing the presentations often manually label slides with text such as “® XYZ Corporation” or “XYZ Confidential.” To be consistent throughout the presentation, the labeling can be done using the ‘Master Slide’ feature of applications, such as MS Power Point. However, employees may sometimes forget to label the content. In addition, it is difficult to consistently label all parts of a presentation: while static pre-authored content, such as presentation slides, can be labeled easily, this is not true for dynamic content such as live software demos or videos.

On a related matter, presentation recording technologies are become increasingly more popular, and various organizations are starting to create multimedia archives of presentations. These archives can only be fully utilized as corporate knowledge sharing tools in conjunction with access control, search and content management technologies. For example, limiting access to certain slides to authorized employees is a must-have feature for corporate presentation archives. In this context, automatically labeling content may not only provide the basis for subsequent access control, but also facilitate content-based access to presentation materials via advanced search or content management features.

There is a need in the art to be able to dynamically and automatically brand or label projected or shared computer screens. Additionally, there is a need in the art to dynamically label archived recordings of computer screens to enable access control, perform searches and manage content.

### SUMMARY

The subject invention describes methods and apparatus for assuring that branding or other labels properly appear at all times when images are shared, such as by projecting a presentation. In addition, the subject invention utilizes the automatic labeling for access control and corporate content management. In the context of this invention, image refers to anything that can be displayed on a computer screen, such as a PowerPoint presentation, a Word document, a web page, a software demonstration, a digital image, a video clip, etc. That is, the term image is not used herein to indicate a format such as jpg, gif, etc. In that sense, the term image as used herein covers displaying static images, such as pictures, but also dynamic images, such as software demonstrations, animations, videos, etc.

According to an aspect of the invention, a method for automatically overlaying a label over a computer generated image is provided, the method comprising: causing the computer to monitor a sharing event of a shared image; when a sharing event has been detected, causing the computer to overlay at least one of a pre-stored or dynamically generated labels over the shared image. The sharing event may comprise transmitting the shared image to a projector or another computer. The sharing event may also comprise detecting a print screen operation. The sharing event may be displaying the shared image using at least one of a wired or wireless projector or another computer. The sharing event may comprise a user interaction selected from a configurable list of user interactions. The list of configurable interactions may be, e.g., a print screen operation or activating a presentation mode of a PowerPoint presentation. The method may further comprise, upon detection of a sharing event, causing the computer to analyze the shared image to determine whether any of pre-stored label is already present in the shared image and if so, avoiding overlaying the pre-stored label. The method may further comprise causing the computer to overlay a machine readable code onto the shared image. The method may further comprise storing a data file comprising data relating to the shared image and linking the data file to the machine readable code. The method may further comprise encoding meta-data into the machine readable code. The method may further comprise causing the computer to monitor a sharing event by causing the computer to monitor activity on any of the computer's ports. The method may further comprise archiving the shared image by performing the steps of causing an archiving system to read and decode the machine readable code and file the document in accordance with data deciphered from decoding the machine readable code.

According to another aspect of the invention, a computerized system for automatically applying labeling to shared images is provided, comprising: a central processing unit (CPU); a memory; a plurality of hardware ports; a bus enabling communication among the CPU, the memory and each of the plurality of hardware ports; a plurality of software ports stored in the memory; a plurality of device drivers stored in the memory; a labeling application stored in the memory; a plurality of pre-stored labels stored in the memory; and, wherein upon execution, the labeling application monitors activity on each of the plurality of hardware ports and plurality of software ports and, upon detecting activity on an active port of the hardware and software ports, the labeling application applies at least one of the pre-stored or dynamically generated labels onto an image sent over the active port. According to an aspect of the invention, upon detecting activity the labeling application first checks to determine whether proper labeling is already present on the image and, if so, the labeling application avoids applying labeling to the image. The hardware ports may comprise: one or any combination of: VGA port, S-video port, USB port, Firewire port, serial port, parallel port, and wireless or wired network interface ports. The label may comprise a machine-readable code. The labeling application may further code metadata of the document into the machine-readable code. The metadata may comprise one or any combination of: author's name, document date, document subject, and access control. The labeling application may further store metadata of the document in an addressable storage and codes a pointer to the addressable storage into the machine-readable code. Upon detecting activity, the labeling application may check to determine whether the currently running application requires labeling.

Additional aspects related to the invention will be set forth in part in the description which follows, and in part will be apparent from the description, or may be learned by practice of the invention. Aspects of the invention may be realized and attained by means of the elements and combinations of various elements and aspects particularly pointed out in the following detailed description and the appended claims.

It is to be understood that both the foregoing and the following descriptions are exemplary and explanatory only and are not intended to limit the claimed invention or application thereof in any manner whatsoever.

### BRIEF DESCRIPTION OF THE DRAWINGS

FIG. 1 depicts an example of a system suitable for implementation of an embodiment of the invention.

FIG. 2 depicts an example of a process executed.

FIG. 3 depicts an example of a PowerPoint slide labeled according to an embodiment of the invention.

### DETAILED DESCRIPTION

The subject invention provides a dynamic content labeling tool and method that address the two problems discussed above: 1. dynamically branding and labeling projected or shared screens or documents, and 2. dynamically labeling projected or shared screens or documents to enable access control, search and content management features. In both cases embodiments of the invention provide customizable system tool that display screen overlays to automatically label content. The tool requires minimal user interactions, because it automatically determines when to display brand or label overlays by (a) monitoring the PC for events that indicate some form of screen sharing (such events may include, but are not limited to VGA output, virtual desktop connections, screen shots, PowerPoint presentation mode, etc.), and by (b) analyzing the current screen (e.g to prevent slides that are already labeled from being re-labeled or branded).

The following two examples illustrate typical usage scenarios and benefits of the subject invention. For the first example, assume that Walter is an employee of XYZ Corporation and he frequently uses his laptop to give presentations to potential customers and/or trade-show attendees. Walter's presentations typically consist of a combination of slides, software demos and videos. Since Walters presentations are often partially recorded by third parties (e.g., reporters taking photos, video capture for TV, screen capture technology at the presentation venue, etc.) consistent branding of all presented content is of critical importance. Also, XYZ Corp. may have a policy of confidentiality labeling of each document, which Walter must follow. Walter uses the proposed invention, e.g. in its embodiment as a system tray tool, to ensure that content is never presented without required logos or other labels that indicate confidentiality, IP ownership, etc. Walter customizes the tool by instructing it to display XYZ's logo in the upper right corner of the screen whenever the laptop's VGA port is in use, when a screenshot is taken, or when the laptop is in MS PowerPoint's full screen presentation mode. Similarly, he customizes the tool to display a confidentiality notice at the center-bottom of the screen. However, since Walter frequently uses slides that are already labeled, he further instructs the tool to only display XYZ's logo and the confidentiality notice when they are not already visible. To support this feature, the tool allows Walter to specify logos, labels, and/or presentation templates whose presence on the screen causes the tool to disable its overlay display. As a result, Walter can present properly labeled slides without worrying that the tool will interfere with the slide design. However, when he displays slides or other screens that are not properly labeled, the tool seamlessly overlays the proper labels. Likewise, when Walter switches from PowerPoint to a software demo or video, the tool displays the proper labels overplayed over dynamic content, thereby ensuring that Walter's content is always labeled properly and consistently, without any required user interactions at presentation time.

For the second example, assume that Walter also frequently uses his laptop to give presentations in XYZ's Corp. conference rooms. Further assume that XYZ Corp, like many other companies, uses a presentation capture system that archives presentations for corporate information sharing purposes. Since Walter frequently presents in confidential senior staff meetings, as well as general company meetings that are open to all employees, he must be able to ensure that certain presentations, once captured, are only accessible to authorized employees. Walter uses the tool of the invention, e.g. in its embodiment as a system tray tool, to ensure that presentations are never displayed without a machine-readable indicator (e.g. a barcode) that communicates meta-data to the presentation capture system. Examples of such meta-data include author information, access rights, a target workspace in a content management system, etc. XYZ Corp's presentation capture system interprets the displayed meta-data indicator and automatically ensures that all materials are automatically routed to the right workspace in the content management system, are only accessible by authorized employees, and are associated with the right author information or other communicated meta-data. Since the tool can optionally overlay the communicated meta-data in human-readable form (along with the machine-readable indicator), Walter is very unlikely to give presentations that are not appropriately protected. Walter customizes the tool by instructing it to display machine and human-readable meta-data whenever the laptop VGA port is in use. He also pre-defines various presentation profiles (e.g. “senior staff only” and “all employees”) to ensure that he can quickly switch between profiles at presentation time, if necessary.

In addition to providing the capture component of an access control solution for Walter's presentations, the invention also enables enhanced content management and search functions. For example, XYZ Corp's staff can now search for presentations given by Walter on a given date or period, significantly boosting the utility of XYZ Corp's presentation archive, without burdening its users with significant interaction overhead. To further reduce any user interaction at presentation time, Walter can optionally use the proposed invention to pre-generate machine-readable indicators and permanently paste them into presentation slides. When the tool detects the presence of a machine-readable indicator on the screen, it won‘t overlay additional indicators. This way, Walter can construct presentation templates that include machine-readable meta-data, which means that no user interaction is required at presentation time to ensure that presentations are protected or routed appropriately.

As an additional side effect, a change in the displayed machine-readable identifier (e.g. a change of author or access right information) helps XYZ Corp's presentation capture system to automatically determine presentation boundaries.

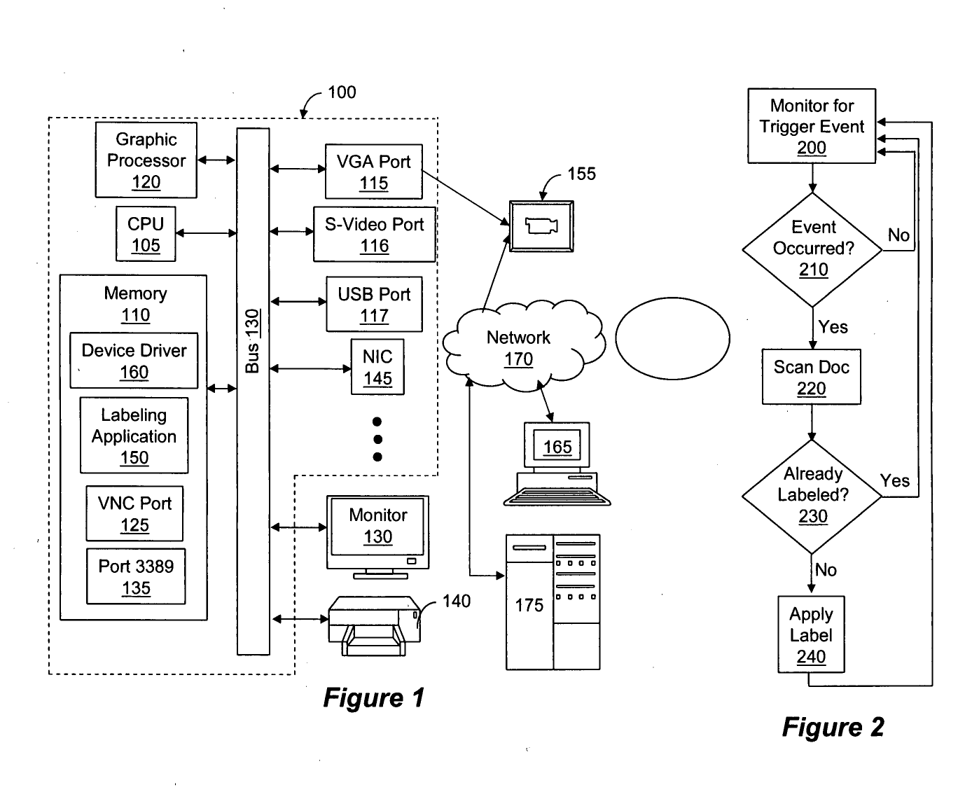

FIG. 1 depicts an example of a system 100, suitable for implementation of an embodiment of the invention. The system 100 may be a general-purpose computer, such as a PC or Mac, programmed to execute processes according to embodiments of the invention. The system 100 generally comprises a CPU 105 that communicates with various components and peripherals via bus 130 in a conventional manner. The CPU 105 utilizes memory 110, in the form of RAM, ROM, hard drive, etc., which for simplicity are depicted as a single block, but in practice may be several separate hardware devices. Similarly, the CPU 105 utilizes the graphic processor 120 in a conventional manner. The memory also stores various executable programs, such as device driver 160 and a labeling application 150 according to an embodiment of the invention. Device driver 160 enables communication with the peripherals such as monitor 130 and printer 140. The ports 115, 125, 135, 145, etc. maybe hardware ports, such as the VGA port 115 and NIC 145, or virtual ports, such as VNC port 125 and port 3389, which are virtual data connection that can be used by programs to exchange data directly, instead of going through a file or other temporary storage location.

For that matter, VNC stands for Virtual Network Computing and is a desktop sharing system which uses the RFB (Remote FrameBuffer) protocol to remotely control another computer. It transmits the keyboard presses and mouse clicks from one computer to another and relays the screen updates back in the other direction, over a network. The original VNC source code is open source under the GNU General Public License, as are many of the variants of VNC. Similarly, port 3389 is used by Microsoft's “Terminal Server” or “Terminal Services” which were renamed to “Remote Desktop” for their appearance in Windows XP. Terminal Server/Remote Desktop allows a remote client to remotely logon to a properly equipped and enabled machine and to then display a fully graphical desktop from that remote machine. NIC stands for Network Interface Card and it is a piece of computer hardware designed to allow computers to communicate over a computer network 170, such as an intranet or the Internet. Whereas network cards used to be expansion cards to plug into bus 130, most newer computers have a network interface built into the motherboard.

The system 100 may access a network 170, such as an intranet or the Internet, via, e.g., NIC 145. Various documents residing in the memory 110 can be shared with other computers, e.g., 165, over the network 170. The documents may also be shared by projecting them using projector 155, either connected to a port, such as VGA port 115, or connected via the network 170.

FIG. 2 depicts an example of a process executed by the CPU 105, per the instructions included in labeling application 150, e.g., a system tray application. The CPU 105 continuously scans for a triggering event that indicates sharing of an image, Step 200. A triggering event can be loosely defined as “sharing” of the PC screen. Such an event may include, but are not limited to: i. use of VGA port, ii. use of a computer sharing virtual port, iii. projecting a document using a projector (e.g., via NIC card 145 or wireless port (not shown)), iv. using full screen presentation mode of presentation application, such as MS PowerPoint. The triggering event may be limited to a certain class of applications. For example, it may be set to trigger upon occurrence of any of conditions i-v above, but only if the current running application is MS PowerPoint™ or MS Word, so that it will not triggered if, for example, an MS Excel™ spreadsheet is sent to a projector.

Once a triggering event is detected in Step 210, the process proceeds to optional Step 220 to scan the image and to Step 230 to analyzed the image to determine whether it already includes proper labeling. In this matter, it should be appreciated that every page or every screen of the documents needs to be analyzed separately, as some pages may be labeled while other may not. If the projected page, i.e., image, includes a proper label, no further action is taken. However, if a proper label is missing, the system 100 applied a proper label at Step 240. The labeling may be selected from a pre-stored or a dynamically generated label.

As is well known, various organizations employ a capturing system that captures various events occurring in conference rooms, such as voice and/or video recording, recording of content of interactive or passive boards, and content projected on a projection screen. The content is saved in a storage system, e.g., server 175, connected to the conference room via a network 170. The capturing system includes certain intelligence that enables search and retrieval of stored content. In order to facilitate and enhance the management, search, and retrieval function of the capturing system, according to a feature of the invention the label applied to the document in step 240 of FIG. 2 includes a unique machine-readable indicator, e.g., a barcode. When the capturing system receives a document for storage, it reads the indicator and fetches metadata corresponding to the indicator. The metadata may be designed to assist in filing the documents if the capturing system uses a defined filing scheme, e.g., by dates, by authors, by subject, by type, etc. The metadata may also enable easier searching and control for retrieval of documents. That is, the metadata may also include access code, e.g., public, confidential, executives only, etc. so that only personnel with proper authorization may retrieve any specific document.

The machine-readable identifier may either directly encodes user-defined data or encodes an identifier that is associated with user-defined data stored elsewhere. For example, instead of encoding metadata directly, the tool can encode a URL or on ID that identifies a record in a database. Examples of Supported metadata include, but are not limited to, author names, access rights (e.g. an access control list indicating user accounts permitted access) and storage information, such as target folder in a content management system.

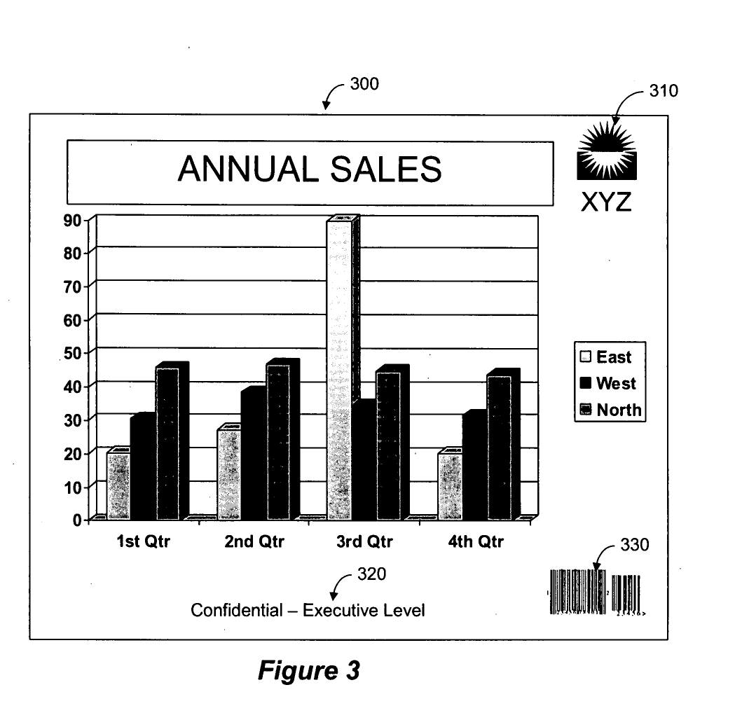

FIG. 3 depicts an example of a PowerPoint slide 300 of XYZ Corp. According to XYZ policy, each such slide should include XYZ's logo, 310, a confidentiality and/or access notice 320, and a machine-readable indicator 330 containing metadata, such as the author, the subject, access permission, etc. According to embodiments of the invention, whenever a triggering event is detected, the system checks to see whether the logo 310, notice 320, and indicator 330 are present. If not, the system automatically applies the missing label to the document. As can be understood, the same process would be applied to other documents or images such as video presentations, software demos etc.

In any of the embodiments described herein, the screen overlays may be made to be customizable. For example, the user can specify a corporate logo, text or image-based labels, as well as metadata to be displayed as a machine-readable identifier. The user may also be given the option to define overlay profiles that the system can apply to various images. Each profile may include unique combination of logo, text, notices, barcode, etc. In this way, the right profile can be easily selectable before or during the presentation.

The implementation of overlaying logos, labels or machine-readable identifiers is straight-forward under MS Windows™ operating systems, by setting the window style for the tray application to TOPMOST. To ensure that the overlay remains visible, one may use a timer that periodically resets the window to TOPMOST, or alternatively, write a system hook to get notified of WM_ACTIVE messages and reset the window to TOPMOST.

To detect visible logos, labels or machine-readable identifiers, any of the following alternative implementation may be used. Image-analysis: detecting whether a specified image, such as a logo, is currently visible on a computer-screen can be accomplished with any known image analysis algorithm. An example of one such algorithm is described in Hall, D., Pelisson, F., Riff, O., Crowley, J., Brand Identification Using Gaussian Derivative Histograms, in Machine Vision and Applications, Vol. 16(1), 41-46 (2004). However, according to an embodiment of the invention, the image analysis algorithm is applied to the screen selectively. That is, since the described invention operates under real-time constraints, efficiency is critical. Therefore, according to this embodiment of the invention, image detection is limited to regions at the screen where logos or other labels are known to appear. Consequently, the computational cost can be greatly reduced. For example, the user could indicate the exact position of a logo to be detected, which would lead to a trivial, and therefore highly efficient, image detection algorithm.

Detecting classes of similar image types, e.g. detecting a barcode or QR code (Quick Response Code), instead of detecting an exact image match, is technically feasible as well. According to embodiments of the invention, barcode detection could either be implemented by limiting detection to a set of pre-defined barcodes (that can be matched exactly) or by using special-purpose algorithms, such as the barcode detector described by Jam and Karu in Learning Texture Discrimination Masks, Pattern Analysis and Machine Intelligence, Vol. 18(2), 195-202, 1996.

As an alternative to image analysis techniques, another embodiment utilizes knowledge about specific presentation software. For example, on Windows platforms, a process can attach to a running instance of MS PowerPoint, thereby obtaining access to the Domain-Object-Model (DOM) of a presentation. The DOM can then be utilized to efficiently determine if certain images, textual labels or other visual features are currently visible.

Detection of screen sharing may be implemented using various techniques. According to one embodiment, network-based screen sharing detection is implemented. On Windows FCs, the inventive tool can detect VNC connections by analyzing TCP activity on port 5900 (default VNC port). Similarly, MS remote desktop connections can be detected by monitoring port 3389 (default port for MS remote desktop). In cases where users might have modified the default port numbers of their terminal servers, the tool can read the current port number from the registry(http://support/microsoft.com/default.aspx?scid=kb:en-us:q187623).

Port monitoring tools can be easily implemented based on publicly available tools and source code. For example, open source projects such as TCPinfo (http://www.codeproject.com/internet/tcpinfo.asp) illustrates technical details of port monitoring software.

The triggering events of PrintScreen and/or screen shot may be detected as follows. On MS Windows, the PrintScreen function (usually triggered by the PrtScm key) allows users to quickly copy the content of a window or the entire screen (alt-PrtS cm) to the clipboard for further processing or pasting into applications. The proposed tool can detect such actions using a system-wide keyboard hook (further technical details are available at (http://answers.google.com/answers/threadview?id=133059) or in the article Tutorial, Keyboard Hook, available at http://www.ragestorm.net/tutorial?id=10.

Detecting use of VGA port may be implemented as follows. Modem operating systems usually provide API's for detecting enabled displays. On Windows XP, for example, API methods such as EnumDisplayDevices, EnumDisplayMonitors, and EnumDisplaySettings can be used to list connected displays and monitor their status. Code examples are publicly available, for example at http://www.realtimesoft.com/multimon/programming/basics.asp.

Detecting networked projection may be done as follows. Windows Vista will support the Windows Network Projector standard (http://windowshelp.microsoft.com/Windows/en-US/Help/34c64a66-7f20-40e3-9202-470b0eea36391033.mspx) to enable seamless setup and connectivity for networked projectors (such as, for example, Sony's VPLFX51 LCD Network Data Projector). Vista automatically detects nearby network projectors and allows users to easily project screens onto any accessible network projector. Since network projectors are directly supported by the operating system, information about currently connected projectors is available to any application.

Encoding user-defined meta-data in machine-readable codes may be performed as follows. According to embodiments of the invention, users are allowed to specify meta-data, such as author information, access rights or desired storage locations. The envisioned usage model is as follows. To minimize user interactions at presentation time, users can specify meta-data before giving a presentation. A set of meta-data can be saved as a “profile.” For example, meta-data that identifies user “Walter” as the author of a presentation that is only accessible to users who belong to access control list “sales” could be specified once and then saved as a named profile, such as “Walter Sales.” The proposed tool converts the provided meta-data into a machine-readable code such as a barcode or any of several available 2-dimensional codes such as data matrix barcodes, QR codes, and shot codes. The amount of text that can be encoded in a barcode or QR code depends on the specific encoding format used. In the context of this invention, the use of machine-readable codes is further constrained by image size and resolution limits. Clearly, codes should not distract from the actual presentation content; however, limiting the size of complex codes may lead to recognition problems down the line, especially if the screen is not captured at full resolution. To address this issue, a simple barcode format. e.g. UPC can be used to encode an identifier that is associated with a set of user-defined meta-data. Another embodiment utilizes shot codes which were developed with the express purpose of encoding only a URL in a robust and easily readable way. The implementation of this approach is straight forward: when users specify meta-data, the tool stores the meta-data along with a generated identifier on a central server. When a screen capture system reads the machine-readable identifier on a captured screen, it retrieves the corresponding meta-data from the server.

According to yet another embodiment, various computer executable instructions may be stored along with the meta-data. When a machine reads the code which directs it to the location on the server where the metadata is stored, the machine also reads the instructions and execute these instructions.

Thus, while only certain embodiments of the invention have been specifically described herein, it will be apparent that numerous modifications may be made thereto without departing from the spirit and scope of the invention. For example, VGA dongles or PC graphics cards could overlay information that uniquely identifies a user or always overlays a corporate logo. Likewise, similar overlay features can be integrated into operating system. Further, certain terms have been used interchangeably merely to enhance the readability of the specification and claims. It should be noted that this is not intended to lessen the generality of the terms used and they should not be construed to restrict the scope of the claims to the embodiments described therein.

All documents cited and referenced are incorporated herein by reference in their entirety.

1. A method for automatically overlaying a label over a computer generated image, comprising:
causing said computer to monitor a sharing event of the computer generated image;
when a sharing event has been detected, causing said computer to overlay at least one of a pre-stored or dynamically generated label over the computer generated image.

2. The method of claim 1, wherein said sharing event comprises displaying the shared image using at least one of a wired or wireless projector or another computer.

3. The method of claim 1, wherein said sharing event comprises a user interaction selected from a configurable list of user interactions.

4. The method of claim 1, wherein said sharing event comprises an explicit user request to activate the labeling function.

5. The method of claim 1, further comprising, upon detection of a sharing event, causing the computer to analyze the shared image to determine whether proper labeling is already present in the shared image and if so, avoiding overlaying the pre-stored or dynamically generated label.

6. The method of claim 1, wherein the label comprises a machine-readable code.

7. The method of claim 5, wherein the label comprises a machine-readable code.

8. The method of claim 6, further comprising storing data comprising information relating to the shared image and linking said data to said machine readable code.

9. The method of claim 7, further comprising storing data comprising information relating to the shared image and linking said data to said machine-readable code.

10. The method of claim 6 further comprising encoding meta-data into said machine-readable code.

11. The method of claim 7 further comprising encoding meta-data into said machine-readable code.

12. The method of claim 1, wherein causing said computer to monitor a sharing event comprises causing said computer to monitor activity on any of said computer's ports.

13. The method of claim 6, further comprising archiving the shared image by performing the steps of causing an archiving system to read and decode said machine readable code and file the image in accordance with data deciphered from decoding said machine readable code.

14. The method of claim 7, further comprising archiving the shared image by performing the steps of causing an archiving system to read and decode said machine readable code and file the image in accordance with data deciphered from decoding said machine readable code.

15. A computerized system for automatically applying labeling to shared image, comprising:
a central processing unit (CPU);
a memory;
a plurality of hardware ports;
a bus enabling communication among the CPU, the memory and each of the plurality of hardware ports;
a plurality of software ports stored in the memory;
a plurality of device drivers stored in the memory;
a labeling application stored in the memory;
a plurality of pre-stored labels stored in the memory; and,
wherein upon execution, said labeling application monitors activity on at least one of the plurality of hardware ports and plurality of software ports and, upon detecting activity on an active port of said hardware and software ports, said labeling application applies at least one of the pre-stored or dynamically generated labels onto an image sent over the active port.

16. The system of claim 15, wherein upon detecting activity said labeling application first checks to determine whether proper labeling is already present in the image and, if so, the labeling application avoids applying labeling to the image.

17. The system of claim 16, wherein the hardware ports comprise: one or any combination of: VGA port, S-video port, USB port, Firewire port, serial port, parallel port, and wired or wireless network interface ports.

18. The system of claim 17, wherein the label comprises a machine-readable code.

19. The system of claim 18, wherein the labeling application further codes metadata into the machine-readable code.

20. The system of claim 19, wherein the metadata comprises one or any combination of: author's name, image date, image subject, and access control.

21. The system of claim 17, wherein the labeling application further stores metadata in an addressable storage and codes a pointer to the addressable storage into the machine-readable code.

22. The system of claim 21, wherein the metadata comprises one or any combination of: author's name, image date, image subject, and access control.

23. The system of claim 16, wherein upon detecting activity said labeling application checks to determine whether the currently running application requires labeling.
